(19) United States
(12) Patent Application Publication
(10) Pub. No.: US 2015/0118462 A1
(43) Pub. Date: Apr. 30, 2015

(54) COMPOSITE FILMS, METHODS OF MANUFACTURING COMPOSITE FILMS AND APPARATUSES FOR PERFORMING METHODS

(71) Applicant: Samsung Display Co., LTD., Yongin-City (KR)

(72) Inventors: In-Sun HWANG, Suwon-si (KR); Sang-Il PARK, Yongin-si (KR); Jeoung-Sub LEE, Seoul (KR); Min-Hoon CHOI, Seoul (KR)

(73) Assignee: Samsung Display Co., LTD., Yongin-City (KR)

(21) Appl. No.: 14/218,833

(22) Filed: Mar. 18, 2014

(30) Foreign Application Priority Data
Oct. 31, 2013 (KR) 10-2013-0130902

(51) Int. Cl. H04B 1/3888; H04M 1/02; B29C 47/56; B29D 7/01; B29C 47/08

(52) U.S. Cl. CPC H04B 1/3888; B29D 7/01; B29C 47/0813; B29C 47/56; H04M 1/0202; B29L 2031/3475
USPC 428/212; 264/171.1; 425/133.5

(57) ABSTRACT

A composite film may include an elastic film portion having first and second edges that are substantially parallel. The elastic film portion may have a first elasticity. The composite film may also include a first non-elastic film portion extending along and contacting the first edge of the elastic film portion. The first non-elastic film portion may have a second elasticity that is substantially lower than the first elasticity.

### CROSS-REFERENCE TO RELATED APPLICATION(S)

This application claims priority under 35 U.S.C. §119 to Korean patent Application No. 10-2013-0130902, filed on Oct. 31, 2013, the disclosure of which is hereby incorporated by reference herein in its entirety.

### BACKGROUND

1. Technical Field

The present disclosure relates to composite films, methods of manufacturing composite films, and apparatuses for performing methods, and more particularly, to composite films for display devices, methods of manufacturing the composite films, and apparatuses for performing the methods.

2. Description of the Related Art

Recently, a display device having light weight and small size has been required because a user needs enhanced portability and usability of the display device. Thus, a rollable or a bendable display device have been researched and developed. A variety of composite films may be recently utilized for implementing the rollable or bendable display device. An apparatus for forming the composite film may use an injection molding process, an extrusion molding process, a calendaring process, and etc. Generally, an apparatus for forming the composite film using the extrusion molding process may include an extruder, a feed block part, an extruder die part, and etc.

However, the apparatus for forming the composite film using the extrusion molding process may manufacture a composite film including a plurality of resin layers vertically arranged by forming a plurality of melted resins from a plurality of extruders, by arranging the melted resins along a longitudinal direction, and by extruding the melted resins from the extruder die part. In this case, each of the resin layers may have a single region of a single material, so that the composite film including the resin layers may not reduce a stress generated in folding of the display device. As a result, the display device may be damaged by the stress.

### SUMMARY

Example embodiments provide a composite film capable of preventing a damage caused by a stress generated when the display device is folded or bent.

Example embodiments provide a method of forming the composite film.

Example embodiments provide an apparatus for performing the method of forming the composite film.

According to one aspect, a composite film includes an elastic film portion and a first non-elastic film portion. The elastic film portion has first and second edges that are substantially parallel, and the first non-elastic film portion extends along and contacts the first edge of the elastic film portion. The elastic film portion has a first elasticity, and the first non-elastic film portion has a second elasticity that is substantially lower than the first elasticity.

In example embodiments, the composite film further comprises a second non-elastic film portion extending along and contacting the second edge of the elastic film portion. The second non-elastic film portion has a third elasticity that is substantially lower than the first elasticity.

In example embodiments, the elastic film may include an elastomer selected from the group consisting of polypropylene (PP), polymethylmethacrylate (PMMA), and polydimethylsiloxane (PDMS).

In example embodiments, the first and second non-elastic films may each include an engineering plastic. More specifically, the first and second non-elastic films may include an engineering plastic selected from the group consisting of acrylonitrile butadiene styrene (ABS), nylon 6, nylon 6-6, polyamides (PA), polybutylene terephthalate (PBT), polycarbonates (PC), polyetheretherketone (PEEK), polyetherketone (PEK), polyethylene terephthalate (PET), polyimides, polyoxymethylene plastic (POM/Acetal), polyphenylene sulfide (PPS), polyphenylene oxide (PPO), polysulphone (PSU), polytetrafluoroethylene (PTFE/Teflon), polyvinyl chloride (PVC), and ultra-high-molecular-weight polyethylene (UHMWPE/UHMW).

According to another aspect, there is provided a method of forming a composite film. In the method, a first melted resin is extruded to provide a first extruded resin, and a second melted resin is extruded to provide a second extruded resin. The first and second extruded resins may be arranged along a first direction such that the first direction crosses the first and second extruded resins. The first and second extruded resins may be re-arranged along a second direction other than the first direction such that the second direction crosses the first and second extruded resins. The first and second resins may subsequently be extruded to produce a film comprising a first film portion and a second film portion such that the second direction crosses the first and second film portions, the first film portion being made of the first extruded resin, and the second film portion being made of the second extruded resin.

In example embodiments, the method of forming a composite film may further comprise melting a first solid resin to provide the first melted resin, melting a second solid resin to provide the second melted resin, melting a third solid resin to provide a third melted resin, and extruding the third melted resin to provide a third extruded resin.

In example embodiments, when extruding the first, second, and third melted resins, the method further comprises controlling an extrusion speed of each of the first, second, and third melted resins based on the size of the resulting extruded resin produced therefrom.

In example embodiments, when the size of the first melted resin is equal to the size of the second melted resin, and the size of the third melted resin is smaller than the sizes of the first and second melted resins, an extrusion speed of the third melted resin is lower than extrusion speeds of the first and second melted resins.

In example embodiments, the method further comprises cooling the first and second extruded resins to produce the film.

According to still another aspect, an apparatus for forming a composite film includes first extruders, a feeder, a direction converter, and a second extruder. The first extruders are configured to extrude a first melted resin and a second melted resin to provide a first extruded resin and a second extruded resin. The feeder is configured to arrange the first and second extruded resins along a first direction such that the first direction crosses the first and second extruded resins. The direction converter is configured to arrange the first and second extruded resins along a second direction other than the first direction such that the second direction crosses the first and second extruded resins. The second extruder is configured to extrude the first and second extruded resins arranged along the second direction to produce a film comprising a first film portion and a second film portion such that the second direction crosses the first and second film portions, the first film portion being made of the first extruded resin, the second film portion being made of the second extruded resin.

In example embodiments, the first extruders comprise a first extruding member configured to melt a first solid resin to extrude the first melted resin, a second extruding member configured to melt a second solid resin to extrude the second melted resin, and a third extruding member configured to melt a third solid resin to extrude a third melted resin.

In example embodiments, each of the first, second, and third extruding members includes a screw.

In example embodiments, the apparatus includes a controller configured to control extrusion speeds of the first, second, and third melted resins based on the sizes of the first, second, and third melted resins, respectively.

In example embodiments, when the size of the first melted resin is equal to the size of the second melted resin, and the size of the third melted resin is smaller than the sizes of the first and second melted resins, an extrusion speed of the third melted resin is controlled to be lower than extrusion speeds of the first and second melted resins.

In example embodiments, the direction converter includes a supply line arranged in the first direction and configured to receive the first and second melted resins arranged in the first direction, a discharge line arranged in the second direction and configured to discharge the first and second melted resins arranged in the second direction, and a converting line disposed between the supply line and the discharge line and configured to re-arrange the first and second melted resins, which are arranged in the second direction, in the second direction.

In example embodiments, the first direction may correspond to a thickness direction of the composite film and the second direction may correspond to a transverse direction of the composite film perpendicular to the thickness direction.

In example embodiments, the second extruder includes a melted resin supply configured to receive the first and second melted resins arranged in the second direction, a manifold coupled to the melted resin supply, and a melted resin extruder coupled to the manifold to extrude the first and second melted resins arranged in the second direction.

In example embodiments, the apparatus may additionally include a cooler configured to cool the first and second extruded resins.

According to example embodiments, the composite film may include an elastic film and an inelastic film. Here, the elastic film may be horizontally disposed between the inelastic films. For example, the composite film may include a first inelastic film, an elastic film, and a second inelastic film, arranged along the transverse direction perpendicular to the thickness direction of the composite film. Therefore, the composite film may prevent or reduce the damage (e.g., high temperature deformation, crack) caused by the stress generated when the display device is folded or bent.

### BRIEF DESCRIPTION OF THE DRAWINGS

Illustrative, non-limiting example embodiments will be more clearly understood from the following detailed description taken in conjunction with the accompanying drawings.

FIG. 1 is a plan view illustrating an apparatus for forming a composite film, according to an example embodiment.

FIG. 2 is a cross-sectional view illustrating a first extruding unit in FIG. 1, according to an example embodiment.

FIG. 3 is a perspective view illustrating a converting unit in FIG. 1, according to an example embodiment.

FIG. 4 is a perspective view illustrating a second extruding unit in FIG. 1, according to an example embodiment.

FIG. 5 is a flow chart illustrating a method of forming a composite film using the apparatus in FIG. 1, according to an example embodiment.

FIG. 6 is a plan view illustrating a composite film obtained using the apparatus in FIG. 1, according to an example embodiment.

### DETAILED DESCRIPTION OF THE EMBODIMENTS

Hereinafter, composite films used for display devices, methods of manufacturing composite films and apparatus for performing methods will be explained in detail with reference to the accompanying drawings.

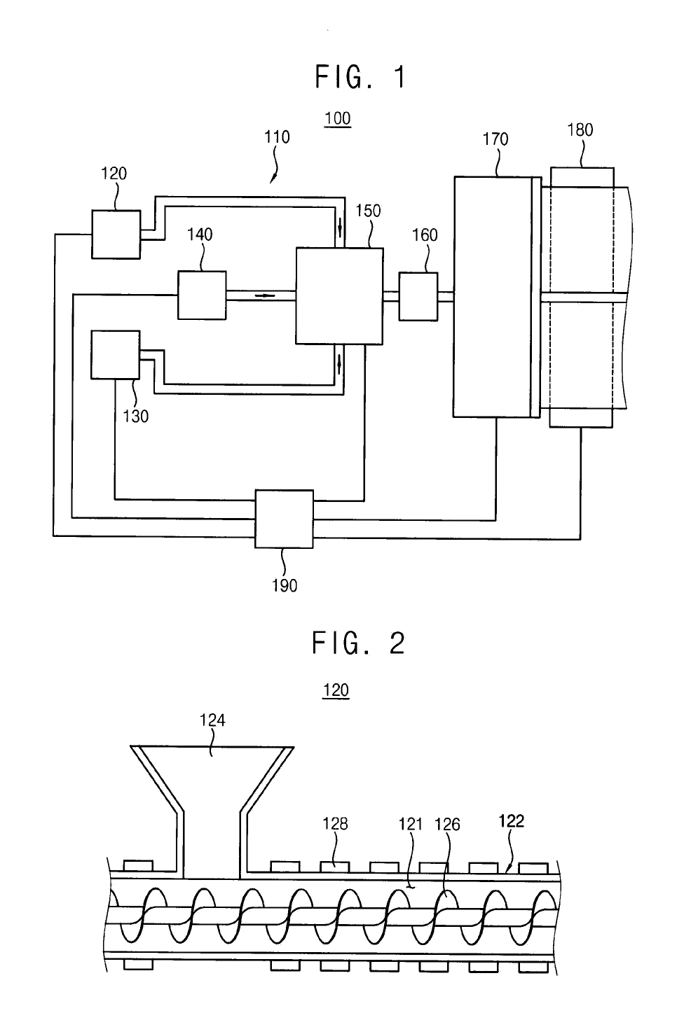

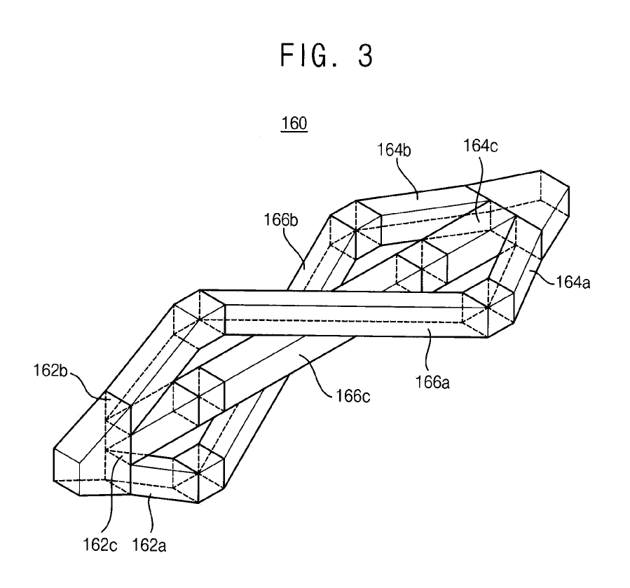

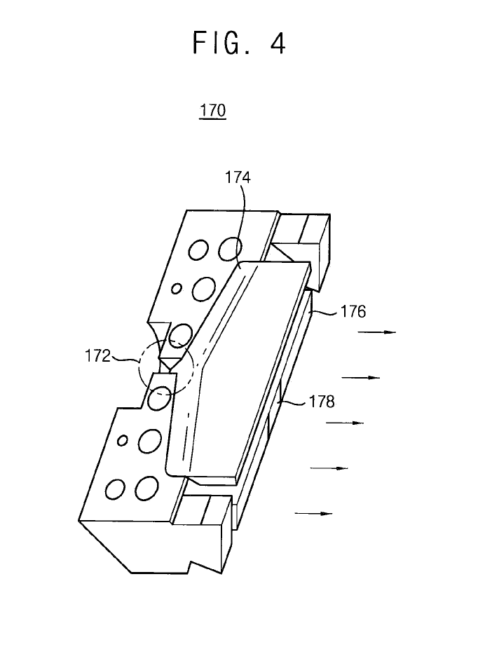

FIG. 1 is a plan view illustrating an apparatus in accordance with an example embodiment. FIG. 2 is a cross-sectional view illustrating a first extruding unit in FIG. 1, according to an example embodiment. FIG. 3 is a perspective view illustrating a converting unit in FIG. 1, according to an example embodiment. FIG. 4 is a perspective view illustrating a second extruding unit in FIG. 1, according to an example embodiment.

Referring to FIGS. 1 through 4, an apparatus 100 for forming a composite film may include a first extruding unit 110, a feeding unit 150, a converting unit 160, a second extruding unit 170, a cooling unit 180, and a controller 190.

The first extruding unit 110 may extrude at least two melted resins. In example embodiments, the first extruding unit 110 may include a first extruding member 120 configured to melt a first solid resin to extrude a first melted resin, a second extruding member 130 configured to melt a second solid resin to extrude a second melted resin, and a third extruding member 140 configured to melt a third solid resin to extrude a third melted resin. Although in the example embodiments are described as having three resins (e.g., first, second, and third), the present disclosure is not limited to such configuration, and other example embodiments may include any other number of resins without departing from the spirit of the present disclosure.

In example embodiments, each of the first and second solid resins may include an engineering plastic. In one embodiment, the engineering plastic is selected from the group consisting of acrylonitrile butadiene styrene (ABS), nylon 6, nylon 6-6, polyamides (PA), polybutylene terephthalate (PBT), polycarbonates (PC), polyetheretherketone (PEEK), polyetherketone (PEK), polyethylene terephthalate (PET), polyimides, polyoxymethylene plastic (POM/Acetal), polyphenylene sulfide (PPS), polyphenylene oxide (PPO), polysulphone (PSU), polytetrafluoroethylene (PTFE/Teflon), polyvinyl chloride (PVC), and ultra-high-molecular-weight polyethylene (UHMWPE/UHMW). In addition, the third solid resin may include an elastic resin. For example, the elastic resin may be an elastomer. Examples of the third solid resin may include silicon-based polymer, acrylic-based polymer, urethane-based polymer, and etc. These may be used alone or in any combination thereof. Particularly, the third solid resin may include polypropylene (PP), polymethylmethacrylate (PMMA) and polydimethylsiloxane (PDMS), and etc. In example embodiments, the elasticity of the first and second solid resins may be substantially lower than the elasticity of the third solid resin. For example, the elastic modulus of the third solid resin may be substantially lower than the elastic moduli of the first and second solid resins. Here, when a first value is “substantially lower” than a second value, such phrase may mean that the first value is about 0.01%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, or about 25% of the second value. The elastic modulus of the third solid resin may be substantially close to zero. For example, in some embodiments, the elastic modulus of the third solid resin may be about 0.1, about 0.5, about 1, about 1.5, or about 2.

It should be understood that although the terms “first,” “second,” and “third” are used herein to describe various elements, these elements should not be limited by these terms. These terms are only used to distinguish one element from another element. Thus, a first element (e.g., first solid resin) discussed below could be termed a second element, and similarly, a second element may be termed a first element without departing from the teachings of this disclosure. Here, although in some examples, the third solid resin is described as being more elastic than the first and second solid resins, but other examples may include a first solid resin or a second solid resin that is more elastic than the others.

Hereinafter, a structure of the first extruding member 120 will be described. Each of the first, second, and third extruding members 120, 130, and 140 may have substantially the same structure.

As illustrated in FIG. 2, the first extruding member 120 may include a housing 122, a hopper 124, a screw 126, and a heater 128.

The housing 122 may include a melting space 121 in which the first solid resin may be received and melted. In example embodiments, the housing 122 may have a substantially cylindrical shape. However, the shape of the housing 122 is not limited thereto.

The hopper 124 may be disposed over the housing 122. The first solid resin may be supplied into the melting space 127 from the hopper 124.

The screw 126 may be disposed in the housing 122. An operation of the screw 126 may be controlled by the controller 190. The screw 126 may transfer the first melted resin to the feeding unit 150 while rotating the first melted resin. In example embodiments, a rotational speed of the screw 126 may be adjusted by the controller 190 based on the size (e.g., surface area perpendicular to the thickness direction of the composite film) of the extruded resin to be extruded from the first melted resin.

The heater 128 may be disposed on the outside of the housing 122. The heater 128 may heat the inside of the housing 122 to thereby melt the first solid resin. The operation of the heater 128 may be controlled by the controller 190.

In example embodiments, the first solid resin may include a material substantially the same as a material included in the second solid resin. Alternatively, the first solid resin may include a material different from the material of the second solid resin.

The feeding unit 150 may be coupled to the first, second, and third extruding members 120, 130, and 140. Thus, the feeding unit 150 may receive the first, second, and third melted resins extruded by the respective first, second, and third extruding members 120, 130, and 140. The feeding unit 150 may arrange the first, second, and third melted resins along a first direction. For example, the first direction may be the thickness direction of a composite film including the first, second, and third extruded resins. In particular, the first melted resin may be located at a lower portion of the composite film, and the second melted resin may be located at a top portion of the composite film. The third melted resin may be interposed between the first melted resin and the second melted resin.

As illustrated in FIG. 1, the converting unit 160 may be coupled to the feeding unit 150, and the converting unit 160 may be configured to receive the first, second, and third melted resins arranged along the first direction. The converting unit 160 may arrange (or re-arrange) the first, second, and third melted resins from the first direction to a second direction. For example, the second direction may be substantially perpendicular to the first direction. Namely, the second direction may correspond to a direction substantially parallel to a transverse direction of the composite film and perpendicular to the thickness direction of the composite film.

As illustrated in FIG. 3, the converting unit 160 may include a supply line 162, a discharge line 164, and a converting line 166. The first, second, and third melted resins arranged along the first direction may be introduced into the supply line 162. The discharge line 164 may discharge the first, second, and third melted resins arranged along the second direction substantially perpendicular to the first direction. The converting line 166 may arrange (or re-arrange) the first, second, and third melted resins from the first direction to the second direction.

In example embodiments, the supply line 162 may include a first supply line 162a, a second supply line 162b, and a third supply line 162c. The third supply line 162c may be disposed over the first supply line 162a, and the second supply line 162b may be disposed over the third supply line 162c. For example, the first supply line 162a, the third supply line 162c, and the second supply line 162b may be sequentially arranged from bottom to top, as shown in FIG. 3. The first melted resin may flow through the supply line 162a, and the second melted resin may flow through the second supply line 162b. Additionally, the third melted resin may be introduced through the third supply line 162c.

In example embodiments, the discharge line 164 may include a first discharge line 164a, a second discharge line 164b, and a third discharge line 164c. The first discharge line 164a may be located on the right side (e.g. when viewed from the supply line 162 in FIG. 3). The second discharge line 164b may be positioned on the left side (e.g. when viewed from the supply line 162 in FIG. 3). The third discharge line 164c may be located between the first discharge line 164a and the second discharge line 164b. For example, the first discharge line 164a, the third discharge line 164c, and the second discharge line 164b may be arranged in directions that are generally parallel to each other, from the right to left as shown in FIG. 3.

In example embodiments, the converting line 166 may include a first converting line 166a, a second converting line 166b, and third converting line 166c. The first converting line 166a may connect the second supply line 162b to the first discharge line 164a. The second converting line 166b may connect the first supply line 162a to the second discharge line 164b. The third converting line 166c may connect the third supply line 162c to the third discharge line 164c. Accordingly, when the first, second, and third melted resins arranged along the first direction reach the discharge line 164 after passing through the converting line 166, the first, second, and third melted resins may be arranged along the second direction substantially perpendicular to the first direction.

According to example embodiments, the number of above-described lines (e.g., first, second, and third lines) may depend on the number of supplied resins. That is, the number of the above-described lines may increase or decrease depending on the number of resins used to form the composite film.

Referring now to FIG. 1, the second extruding unit 170 may be coupled to the converting unit 160 so that the first, second, and third melted resins, which are arranged along the second direction (e.g., transverse direction perpendicular to the thickness direction of the composite film), may be provided to the second extruding unit 170. The second extruding unit 170 may secondarily extrude the first, second, and third melted resins arranged along the second direction.

As illustrated in FIG. 4, the second extruding unit 170 may include a melted resin supply part 172, a manifold part 174, and a melted resin extruding part 176. In example embodiments, the second extruding unit 170 may include a flat die. In some example embodiments, the second extruding unit 170 may include a T-die, a coat hanger die, a fish tail die, and etc.

The melted resin supply part 172 may be connected to the discharge line 164 of the converting unit 160. Thus, the first, second, and third melted resins re-arranged along the second direction may be provided to the melted resin supply part 172.

The manifold part 174 may be coupled to the melted resin supply part 172 to receive the first, second, and third melted resins arranged along the second direction. The manifold part 174 may enlarge the region in which the first, second, and third melted resins are arranged. In this case, the first, second, and third melted resins arranged in the second direction may be expanded along the second direction into the enlarged region of the manifold part 174.

The melted resin extruding part 176 may be coupled to the manifold part 174 to secondarily extrude the expanded first, second, and third melted resins. In example embodiments, the melted resin extruding part 176 may include a plurality of openings 178 through which the first, second, and third melted resins are passed. These melted resins may be extruded while passing through the openings 178. In example embodiments, the openings 178 may be sequentially arranged along the second direction (e.g., the transverse direction of the composite film perpendicular to the thickness direction of the composite film). Although three openings corresponding to the first, second, and third melted resins, respectively, are illustrated, the number of openings in the melted resin extruding part 176 may vary depending on the number of the melted resins.

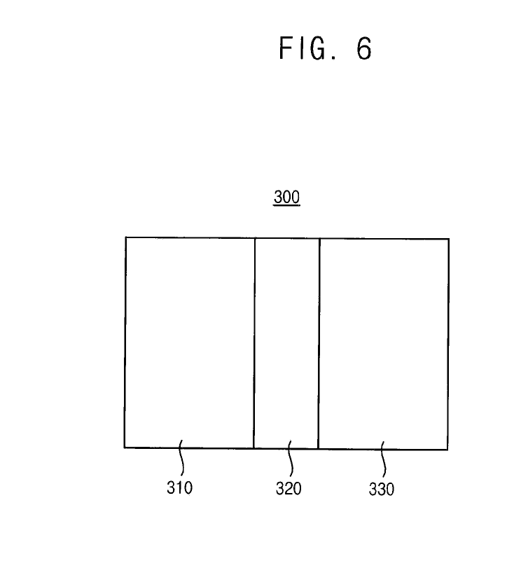

As illustrated in FIG. 1, the cooling unit 180 may cool the first, second, and third melted resins extruded by the second extruding unit 170. Accordingly, a composite film 300 illustrated in FIG. 6 may be obtained. In example embodiments, the cooling unit 180 may include a cooling bath of cooling water or a cooling device such as an air blower.

The controller 190 may adjust rotational speeds of the screws 126 based on the extruding areas of the melted resins. In example embodiments, the controller 190 may control a rotational speed of a first screw of the first extruding member 120 based on the extruding area (e.g., the surface area of the extruded resin perpendicular to the composite film) of the first melted resin, and also may adjust a rotational speed of a second screw of the second extruding member 130 based on the extruding area (e.g., the surface area of the extruded resin perpendicular to the composite film) of the second melted resin. Further, the controller 190 may control a rotational speed of a third screw of the third extruding member 140 based on the extruding area (e.g., the surface area of the extruded resin perpendicular to the composite film) of the third melted resin.

If a region in which the first melted resin is extruded has a first area, a region in which the second melted resin is extruded has a second area substantially smaller than the first area, and a region in which the third melted resin is extruded has a third area substantially the same as the first area, in such a case, the first and third screws may be rotated faster than the second screw by the controller 190. In addition, the controller 190 may control temperatures of the first extruding unit 110, the feeding unit 150, the converting unit 160, and the second extruding unit 170. Thus, viscosities of the first, second, and third melted resins in the first extruding unit 110, the feeding unit 150, the converting unit 160, and the second extruding unit 170 may be efficiently controlled. Accordingly, uniformity of the composite film 300 may be improved.

In example embodiments, the feeding unit 150 may arrange the first, second, and third melted resins along the first direction (e.g., the longitudinal direction). The converting unit 160 may change the first direction of the first, second, and third melted resins into the second direction (e.g., the transverse direction of the composite film). The second extruding unit 170 may extrude the first, second, and third melted resins arranged in the second direction. Therefore, the composite film 300 in FIG. 6 including a first resin 310, a second resin 320, and a third resin 330 that are horizontally (e.g., transverse direction perpendicular to the thickness direction of the composite film) arranged may be obtained. The composite film 300 according to example embodiments may include a plurality of regions of different materials, so that the stress generated when the display device having the composite film 300 is folded or bent may be effectively reduced or removed.

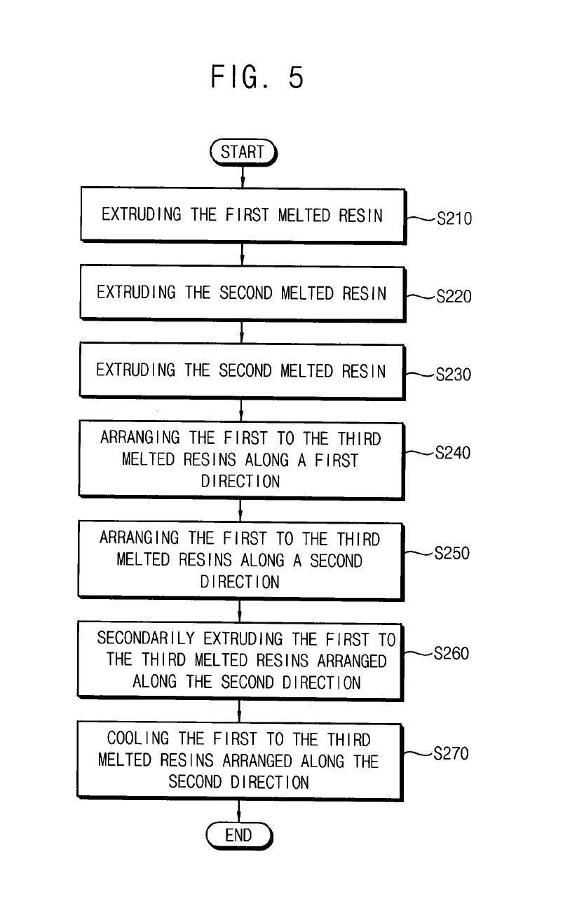

FIG. 5 is a flow chart illustrating a method of forming a composite film using an apparatus in FIG. 1, according to an example embodiment.

Referring to FIGS. 1 and 5, the first extruding member 120 melts the first solid resin, and then the first extruding member 120 extrudes the first melted resin toward the feeding unit 150 in step S210.

The second extruding member 130 melts the second solid resin, and extrudes the second melted resin toward the feeding unit 150 in step S220.

The third extruding member 140 melts the third solid resin and extrudes the second melted resin toward the feeding unit 150 in step S230.

In step S240, the feeding unit 150 vertically arranges the first, second, and third melted resins along the first direction (e.g., the longitudinal direction of the composite film). In example embodiments, the first, second, and third melted resins may be sequentially disposed from bottom to top. In other example embodiments, the melted resins may be disposed in a different order.

In step S250, the converting unit 160 arranges (or re-arranges) the first, second, and third melted resins arranged in the first direction in the second direction (e.g., the transverse direction of the composite film) substantially perpendicular to the first direction. In example embodiments, the first melted resin may be provided to the first supply line 162a, the second converting line 166b, and the second exhaust line 164b. The third melted resin disposed over the first melted resin may be supplied to the third supply line 162c, the third converting line 166c, and the third exhaust line 164c. Further, the second melted resin disposed over the third melted resin may be supplied to the second supply line 162b, the first converting line 166a, and the first exhaust line 164a. When the first, second, and third melted resins arranged in the first direction reach the discharge line 164, the first, second, and third melted resins may be horizontally arranged.

The second extruding unit 170 may secondarily extrude the first, second, and third melted resins arranged along the second direction in step S260.

The cooling unit 180 may cool the first, second, and third melted resins arranged along the second direction to thereby form the composite film 300 of FIG. 6 in step S270. As illustrated in FIG. 6, the composite film 300 may include the first resin film 310, the second resin film 320, and the third resin film 330. Here, the second resin film 320 may be located between the first resin film 310 and the third resin film 330. Thus, the first, second, and third resins 310, 320, and 330 may be arranged in the transverse direction.

When the composite film 300 is combined with a display device, the second resin film 320 may be combined with a first portion of the display device which is rolled or bended. In addition, the first and third resin films 310 and 330 may be combined with a second portion of the display device adjacent to the first portion of the display device. Accordingly, the display device including the composite film 300 may reduce or remove the stress generated when the display device is folded, bent, or rolled. In example embodiments, the composite film 300 may be combined with the display device by interposing an adhesive member (e.g., pressure-sensitive adhesive) between the composite film 300 and the display device.

The method illustrated in FIG. 5 may provide the composite film in which the first, second, and third resin films are sequentially arranged in a horizontal direction. Alternatively, the arrangement of the first resin film, the second resin film and the third resin film may be repeated in the horizontal direction, and then the first, second, and third resin films may be cut from the repeated arrangement. Thus, the mass production of composite films may be efficiently accomplished.

FIG. 6 is a plan view illustrating a composite film manufactured using the apparatus in FIG. 1, according to an example embodiment.

Referring to FIG. 6, a composite film 300 may include a first inelastic film 310, an elastic film 320, and a second inelastic film 330.

In example embodiments, the first inelastic film 310 may be located at a left side of the elastic film 320. The second inelastic film 330 may be located at a right side of the elastic film 320. Thus, each of the first and second inelastic films may have a substantially vertical interface relative to the elastic film 320. For example, the vertical interface between the elastic film 320 and each of the first and second inelastic films may be substantially perpendicular to the transverse direction of the composite film 300 perpendicular to the thickness direction of the composite film 300). Therefore, the display device may be folded or bended centering a vertical line connecting an upper surface of the composite film 300 to a lower surface of the composite film 300.

In example embodiments, the upper surface and the lower surface of the elastic film 320 (which is where the display device is folded or bent) of the composite film 300 is exposed. Thus, only the elastic film 320 of the composite film 300 may be folded or bended when the display device is bended of folded, so that most of the stress generated when the display device is folded or bended may be concentrated at the elastic film 320. As a result, the stress may be efficiently reduced or removed by the elastic film 320 of the composite film 300, and damages to the display device caused by the stress may be prevented.

Example embodiments of the invention may be employed in any one of various electronic devices requiring a composite film. For example, the composite film according to example embodiments may be employed in a notebook computer, a laptop computer, a digital camera, a video camcorder, a cellular phone, a smart phone, a smart pad, a portable multimedia player (PMP), a personal digital assistant (PDA), a MP3 player, a navigation system, a television, a computer monitor, a game console, a video phone, and etc.

The foregoing is illustrative of example embodiments of the present inventive concept and is not to be construed as limitations thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A composite film comprising:
an elastic film portion having first and second edges that are substantially parallel, the elastic film portion having a first elasticity; and
a first non-elastic film portion extending along and contacting the first edge of the elastic film portion, the first non-elastic film portion having a second elasticity that is substantially lower than the first elasticity.

2. The composite film of claim 1, further comprising
a second nonelastic film portion extending along and contacting the second edge of the elastic film portion, the second non-elastic film portion having a third elasticity that is substantially lower than the first elasticity.

3. The composite film of claim 1, wherein the elastic film portion includes an elastomer selected from the group consisting of polypropylene (PP), polymethylmethacrylate (PMMA), and polydimethylsiloxane (PDMS).

4. The composite film of claim 1, wherein the first nonelastic film portion includes an engineering plastic selected from the group consisting of acrylonitrile butadiene styrene (ABS), nylon 6, nylon 6-6, polyamides (PA), polybutylene terephthalate (PBT), polycarbonates (PC), polyetheretherketone (PEEK), polyetherketone (PEK), polyethylene terephthalate (PET), polyimides, polyoxymethylene plastic (POM/Acetal), polyphenylene sulfide (PPS), polyphenylene oxide (PPO), polysulphone (PSU), polytetrafluoroethylene (PTFE/Teflon), polyvinyl chloride (PVC), and ultra-high-molecular-weight polyethylene (UHMWPE/UHMW).

5. A method of forming a composite film, comprising:
extruding a first melted resin to provide a first extruded resin;
extruding a second melted resin to provide a second extruded resin;
arranging the first and second extruded resins along a first direction such that the first direction crosses the first and second extruded resins;
rearranging the first and second extruded resins along a second direction other than the first direction such that the second direction crosses the first and second extruded resins; and
subsequently extruding the first and second extruded resins arranged in the second direction to produce a film comprising a first film portion and a second film portion such that the second direction crosses the first and second film portions, the first film portion being made of the first extruded resin, and the second film portion being made of the second extruded resin.

6. The method of claim 5, further comprising
melting a first solid resin to provide the first melted resin;
melting a second solid resin to provide the second melted resin;
melting a third solid resin to provide a third melted resin; and
extruding the third melted resin to provide a third extruded resin.

7. The method of claim 6, wherein when extruding the first, second and third melted resins, the method further comprises controlling an extrusion speed of each of the first, second and third melted resins in consideration of a size of the resulting extruded resin produced therefrom.

8. The method of claim 7, wherein when the size of the first melted resin is equal to the size of the second melted resin, and the size of the third melted resin is smaller than the sizes of the first and second melted resins, an extrusion speed of the third melted resin is lower than extrusion speeds of the first and second melted resins.

9. The method of claim 5, wherein the film is produced by cooling the first and second extruded resins.

10. An apparatus for forming a composite film, comprising:
first extruders configured to extrude a first melted resin and a second melted resin to provide a first extruded resin and a second extruded resin;
a feeder configured to arrange the first and second extruded resins along a first direction such that the first direction crosses the first and second extruded resins;
a direction converter configured to arrange the first and second extruded resins along a second direction other than the first direction such that the second direction crosses the first and second extruded resins; and
a second extruder configured to extrude the first and second extruded resins arranged along the second direction to produce a film comprising a first film portion and a second film portion such that the second direction crosses the first and second film portions, the first film portion being made of the first extruded resin, the second film portion being made of the second extruded resin.

11. The apparatus of claim 10, wherein the first extruders include:
a first extruding member configured to melt a first solid resin to extrude the first melted resin;
a second extruding member configured to melt a second solid resin to extrude the second melted resin; and
a third extruding member configured to melt a third solid resin to extrude a third melted resin.

12. The apparatus of claim 11, wherein each of the first, second, and third extruding members includes a screw.

13. The apparatus of claim 11, further comprising:
a controller configured to control extrusion speeds of the first, second, and third melted resins based on the sizes of the first, second, and third melted resins, respectively.

14. The apparatus of claim 13, wherein when the size of the first melted resin is equal to the size of the second melted resin, and the size of the third melted resin is smaller than the sizes of the first and second melted resins, an extrusion speed of the third melted resin is controlled to be lower than extrusion speeds of the first and second melted resins.

15. The apparatus of claim 10, wherein the direction converter includes:
a supply line arranged in the first direction and configured to receive the first and second melted resins arranged in the first direction;
a discharge line arranged in the second direction and configured to discharge the first and second melted resins arranged in the second direction; and
a converting line disposed between the supply line and the discharge line and configured to re-arrange the first and second melted resins, which are arranged in the first direction, in the second direction.

16. The apparatus of claim 10, wherein the first direction corresponds to a thickness direction of the composite film and the second direction corresponds to a transverse direction of the composite film perpendicular to the thickness direction.

17. The apparatus of claim 10, wherein the second extruder includes:
a melted resin supply configured to receive the first and second melted resins arranged in the second direction;
a manifold coupled to the melted resin supply; and
a melted resin extruder coupled to the manifold to extrude the first and second melted resins arranged in the second direction.

18. The apparatus of claim 10, further comprising a cooler configured to cool the first and second extruded resins.
